(19) United States
(12) Patent Application Publication
(10) Pub. No.: US 2019/0012355 A1
(43) Pub. Date: Jan. 10, 2019

(54) PROCESS AND SYSTEM FOR TRANSMITTING INFORMATION

(71) Applicant: Robert Bosch GmbH, Stuttgart (DE)

(72) Inventor: Rainer Baumgaertner, Pfaffenhofen (DE)

(21) Appl. No.: 16/069,649

(22) PCT Filed: Nov. 10, 2016
(86) PCT No.: PCT/EP2016/077346

§ 371 Date: Jul. 12, 2018

(30) Foreign Application Priority Data
Jan. 13, 2016 (DE) 102016200322.4

(51) Int. Cl. G06F 17/30; G06F 9/30

(52) U.S. Cl. CPC G06F 17/30569; G06F 13/36; G06F 9/30025

(57) ABSTRACT

A process for transmitting information includes arranging information in a data structure, transmitting the data structure from a first component to a second component with the aid of a transport component and converting the data structure into a first object that implements a predetermined abstract data type. In this context, the data structure includes an instruction for its conversion into the first object.

### FIELD OF THE INVENTION

The present invention relates to the transmission of information. In particular, the invention relates to the transmission of structured information on a data bus of a motor vehicle.

### BACKGROUND INFORMATION

A data bus is provided on board a motor vehicle, in order to interconnect various components. A first component may include a sensor, and a second component may include a control unit, the sensor making certain information available to the control unit. To that end, the sensor may combine the information in a predetermined data structure, and transmit it to the control unit via the data bus.

Traditionally, the data structure includes an ordered sequence of predetermined data fields. In each case, the individual data fields have a preset quantity and follow immediately after one another. If necessary, special fields are also provided for a checksum, a sequence number or other purposes. Usually, both the forming of the data structure on the part of the sensor and the analyzing of the data structure on the part of the control unit are in each instance accomplished with the aid of a process that was created on the basis of a specification. The specification must normally be understandable for a person, so that the processes may be created and checked. As a result, misunderstandings often come about, so that the processes of the sensor and of the control unit are potentially not compatible with each other. The detection of such an incompatibility may be costly.

### SUMMARY OF THE INVENTION

Therefore, an object of the present invention is to provide a technique by which the exchange of information between a first and a second component, particularly on board a motor vehicle, may be improved. The invention achieves this objective with the aid of a process, a computer-program product and a system having the features set forth in the main description herein. Also described are further specific embodiments.

A process for transmitting information includes the steps of arranging information in a data structure, transmitting the data structure from a first component to a second component with the aid of a transport component and converting the data structure into a first object that implements a predetermined abstract data type. In this context, the data structure includes an instruction for its conversion into the first object.

It is thus possible to no longer form the data structure as a mere stringing together of fixed data types, but rather to form it flexibly. Room for interpretation may thereby be reduced. The compatibility of the first component with the second component may be improved. The specification as to which instruction is coupled with which sequence of information within the data structure no longer has to be interpreted by a person or a programmer. Rather, the arrangement of information in the data structure and the removal of information from the data structure may be accomplished in an automated manner with reference to the instruction. By employing the proposed approach, information may be better encapsulated during the transmission between the components. In addition, misuse of the transmitted data structures by a third entity, which does not know the relationship between the instruction and the proposed conversion, may be impeded.

In particular, the abstract data type may include a combination of data together with the definition of all permissible operations that access the data. An application on the part of the second component is thus able to work directly on an object.

The object-oriented manner of programming is already established in many areas, and the transmitting of objects which include information is able to support this approach.

The object is able to allow access to the information solely by use of one or more provided methods. In this context, an access control may also be implemented, which allows access to a predetermined method only to one predetermined second component. Misuse of information may thus be prevented. Ideas or contents to which the information relates may thus be better protected. For example, various manufacturers may produce components on board the motor vehicle, the components being able to communicate with each other with the aid of the transport component, whereby information may be exchanged specifically without allowing an arbitrary access.

It especially may be provided that the data structure includes a description of the object. For instance, the description may be written in a known description syntax, e.g., employing ASN.1 or in an XML variant.

In a further specific embodiment, the data structure includes the object in a serialized form. In this case, the object together with its methods may be mapped in the data structure. In one specific embodiment, an implementation of a method may also be part of the serialized object. Thus, for example, changes to the data structure on the part of the first component may be transmitted transparently to the second component.

It especially may be provided that the data structure is created to be converted into a second object which implements a predetermined abstract data type, and that the second object differs from the first object. In particular, the second object may be an expansion of the first object. For instance, should the first component acquire additional capabilities, it may then expand the data structure, an older second component being able to provide the first object unchanged on the basis of the data structure, and a newer second component being able to provide a second object on the basis of the same data structure, the second object having additional methods, formats, properties or features compared to the first object. In other words, the second object may be downward compatible with respect to the first object. A version management of components in a system, especially on board a motor vehicle, may thus be greatly simplified. In particular, it is possible to update one of the components, without having to update another.

A computer-program product includes a program-code arrangement for carrying out the process described above, when the computer-program product runs on a processing device or is stored on a computer-readable data carrier.

A system, especially on board a motor vehicle, includes a first and a second component that are connected to each other with the aid of a transport component. The first component is equipped to arrange information in a data structure and to transfer the data structure to the transport component, the transport component permitting the transport of the data structure. The second component is equipped to take over the data structure from the data connection, the second component including a conversion unit that is furnished to convert a taken-over data structure into a first object which implements a predetermined abstract data type.

For example, the conversion unit may be provided as a library function. If the first transmitting component is altered, so that the data structure has a different format, then an accompanying conversion unit may also be provided, to be used in the second component. For example, a manufacturer of the first component may make conversion units in library form available to different manufacturers of various second components, so that the implementation of the second components is essentially limited to the access to objects. The actual transport of information or data structures may take place completely transparently for the second component. Conversely, the conversion of information into the data structure and back again into information may be controlled wholly by the first manufacturer, without the manufacturer having to concern itself with the processing of the information on the part of the second component. Cooperation between components and between their manufacturers may thus be improved. Functional safety for the system may be increased. Test cycles are able to be shortened.

It especially may be provided that the first component includes a sensor, the second component includes a control unit or the transport component includes a data bus. In another specific embodiment, both components in each case include a control unit. In a further variant, the first component may also include an actuator which, for example, as “intelligent actuator”, may include a suitable communication capability and processing capability. For instance, the actuator may include an engine control unit, a steering control unit or a brake control unit. In a further variant, one or more of the components is/are defined as software and are able to run on the same execution or processing device. As an example, the components may include programs that are able to run independently of each other and to communicate with each other with the aid of the data structures. The direction in which information is transmitted between the components is arbitrarily selectable.

The present invention is now described in greater detail with reference to the accompanying drawings.

### BRIEF DESCRIPTION OF THE DRAWINGS

FIG. 1 shows a system and a process.

FIG. 2 shows a component of the system from FIG. 1.

### DETAILED DESCRIPTION

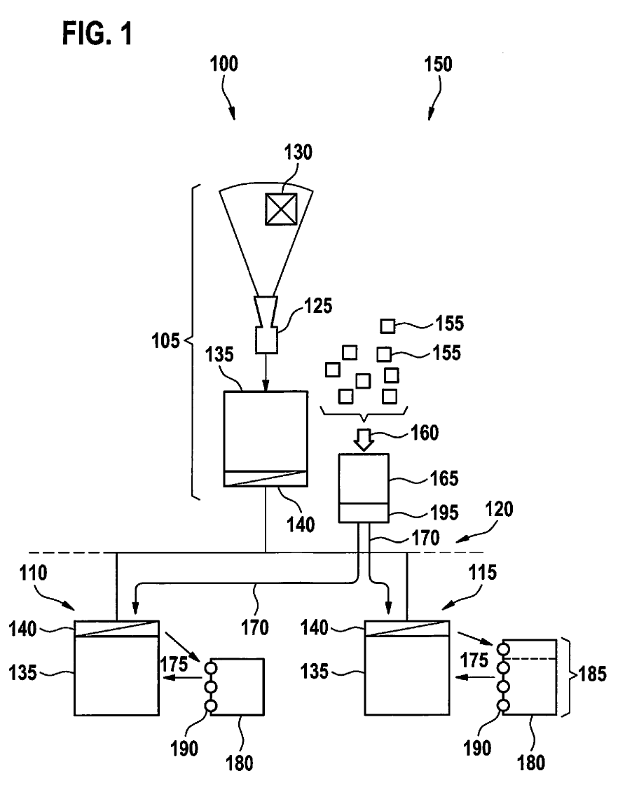

FIG. 1 shows a system 100, especially for use on board a motor vehicle. System 100 includes a first component 105, a second component 110, optionally a third component 115 and a transport component 120 to connect components 105 through 115. In particular, first component 105 may include a sensor, which is coupled to a scanning device 125 for sensing an object 130. As an example, scanning device 125 may include a radar sensor or lidar sensor and object 130 may include a person or a motor vehicle, for instance. However, in another specific embodiment, first component 105 may also include a control unit, for example.

Second component 110 and third component 115 may be each formed by a control device or a control unit. For instance, second component 110 may be provided for implementing an adaptive cruise control (ACC) and third component 115 for implementing a parking assist. Such functionalities are also known as middleware which builds on an existing infrastructure, that especially includes hardware, and may serve as parts of a primary control mechanism, for instance, an autonomous control of the motor vehicle. Both control units 110, 115 are able to draw on information of sensor 105, it being possible for different information needs to be present.

Each of components 105 through 115 includes a functional component 135 and a conversion unit 140. Functional component 135 usually implements only the functionality which is necessary for the processing of information, without dealing with a transport of information. Conversion units 140 are used to make the transmission of information via transport component 120 possible.

It is proposed to conduct information between first component 105 and one of the two components 110 and 115 with the aid of a data structure, which allows conversion units 140 in second component 110 or third component 115 to in each case provide the transmitted information in the form of an object 130 to functional components 135, object 130 in each instance implementing an abstract data type.

In particular, it is proposed in a step 160 in a process 150, to arrange information 155 in a data structure 165, in a step 170, to transmit it with the aid of transport component 120, and in a step 175, to convert it into a first object 180 or a second object 185. In this context, it may be provided that second object 185 is an expansion of first object 180. Both objects 180, 185 include a number of predetermined properties or methods 190. Second object 185 may include at least one additional or expanded method 190. Provided objects 180, 185 may be made available to functional components 135 of components 110, 115.

Conversion unit 140 is able to operate in various modes, which may also be offered simultaneously. In a first mode, a downward compatibility is produced, by the fact that first object 180 is essentially a known struct of basic types (e.g., int, float, bool). First object 180 or a reference to first object 180 is provided. In a second mode, first object 180 is provided with access methods, the access methods being realized on elements of the known struct. The hidden interface is realized as detailed data interface with object-oriented access. In a third mode, an object-oriented access with hidden data interface is realized. In a fourth mode, in addition, an encryption is provided, so that the access to the methods of first object 180 is protected from misuse. Further modes may likewise be realized.

Data structure 165 may be selected in such a way that it contains an instruction as to how data structure 165 is to be converted into object 180 or 185. In one simple specific embodiment, a version number may be indicated for that purpose. In one specific embodiment, instruction 195 includes more extensive information, especially with regard to at least one of methods 190. In a further specific embodiment, instruction 195 they also include a complete definition of one of methods 190. In another specific embodiment, object 180 or 185 may be present in a completely linearized manner in data structure 165. In this case, all properties of object 180, 185 including methods 190 may be given in a predetermined description form. In one specific embodiment, information 155 is also attached.

In the example of sensor 105 above, which transmits information 155 to first component 105 of system 100, for example, measurements of distance to object 130, which were determined with the aid of scanning device 125, may be arranged as information 155 in data structure 165. Data structure 165 is then transmitted to first component 105, and is converted there by conversion unit 140 into first object 180. In one specific embodiment, conversion unit 140 may be provided by a manufacturer of sensor 105, thereby ensuring that first object 180 fits in in a predetermined manner with data structure 165 and information 155. First object 180 may then be used by functional component 135 of first component 105 to determine, for example, whether a longitudinal speed of the vehicle, in which system 100 is installed, must be reduced in order to decrease the danger of running into object 130.

In the same way, third component 115 may also receive data structures 165, which are able to be converted by conversion unit 140 into first object 180. If first component 105 should now be changed, e.g., by using a scanning device 125 with better resolution in the close range, then it may be advantageous to adjust data structure 165, in order to make the more accurate information 155 available to third component 115. It is proposed to adjust data structure 165 in such a way that, like before, it may be converted into first object 180; in addition, however, the possibility exists to convert it into second object 185 which may be downward compatible with respect to first object 180. For instance, an additional method 190 may be provided, which allows the query of a distance to object 130 with improved accuracy, e.g., in the centimeter unit instead of in the meter unit. In so doing, original methods 190 of first object 180 need not be altered. Conversion unit 140 for third component 115 may be also provided by the manufacturer of first component 105. Functional component 135 of third component 115 may then operate in an object-oriented manner on the basis of second object 185, without being affected by the limitations of first object 180.

Employing the proposed technology, it is possible to procure components 105 through 115 from different manufacturers, and to delegate to one of the manufacturers, the responsibility for correct transmission of information 155 or the correct provision of objects 180, 185. Collaboration of development departments of different manufacturers in order to permit the correct transmission of information 155 may no longer be necessary. In particular, the situation where a specification of the data format of data structure 165 understandable for one person is interpreted differently by different people on the part of the various manufacturers may thus be avoided.

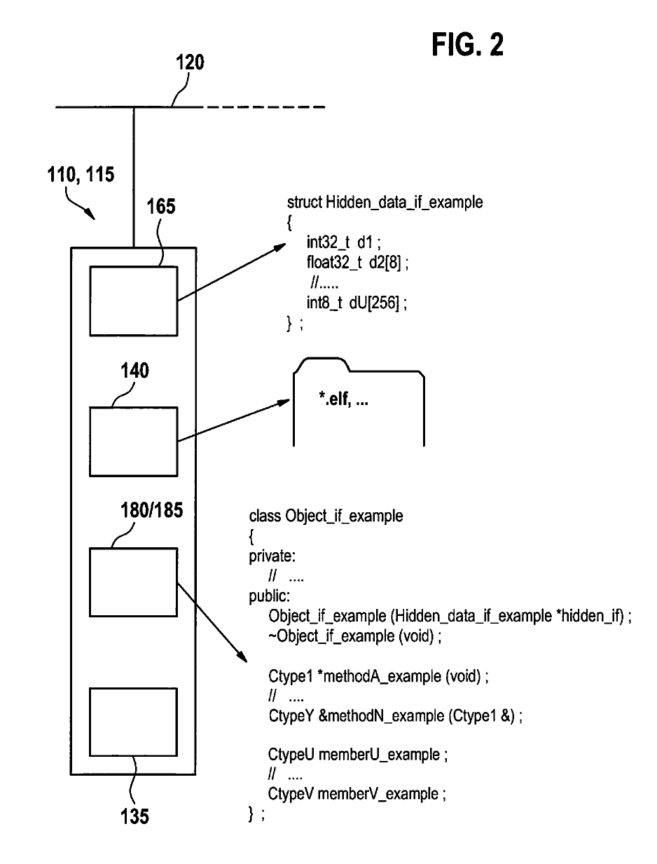

FIG. 2 shows a component 110, 115 of system 100 from FIG. 1. Component 110, 115 receives from transport component 120 a data structure 165, which is represented rudimentarily by way of example in the right section of FIG. 2. Conversion unit 140 may be provided as a library. To that end, a manufacturer of first component 105 may provide a library, for example, or an executable binary program, which implements conversion unit 140 on the part of second component 110 or third component 115. On the basis of data structure 165, conversion unit 140 provides an object 180, 185, that implements a predetermined abstract data type. The abstract data type includes a combination of data (information) together with the definition of all permissible operations that access the data. A fragment of an example for a structure of an object 180, 185 is shown in the right section of FIG. 2.

Provided object 180, 185 may then be made available to functional component 135, which pursues higher abstracted goals like, in the example above, a longitudinal control of the motor vehicle in the case of the adaptive cruise control on second component 110 or an, e.g., acoustic or haptic distance alert in the case of the parking assist on third component 115.

1-10. (canceled)

11. A method for transmitting information, the method comprising:
arranging information in a data structure;
transmitting the data structure from a first component to a second component with the aid of a transport component; and
converting the data structure into a first object, which implements a predetermined abstract data type;
wherein the data structure includes an instruction for its conversion into the first object.

12. The process of claim 11, wherein the abstract data type includes a combination of data together with the definition of all permissible operations that access the data.

13. The process of claim 11, wherein the first object allows access to the information solely by one or more provided sub-methods.

14. The process of claim 11, wherein the data structure includes a description of the object.

15. The process of claim 11, wherein the data structure includes the object in a serialized form.

16. The process of claim 11, wherein the data structure is created to be converted into a second object which implements a predetermined abstract data type, and wherein the second object differs from the first object.

17. The process of claim 16, wherein the second object is an expansion of the first object.

18. A non-transitory computer readable medium having a computer-program, which is executable by a processor, comprising:
a program code arrangement having program code means for transmitting information, by performing the following:
arranging information in a data structure;
transmitting the data structure from a first component to a second component with the aid of a transport component; and
converting the data structure into a first object, which implements a predetermined abstract data type;
wherein the data structure includes an instruction for its conversion into the first object.

19. A system, comprising:
a first component; and
a second component, wherein the first component and the second component are connected to each other with the aid of a transport component;
wherein the first component is configured to arrange information in a data structure, and to transfer the data structure to the transport component,
wherein the transport component is configured to permit the transport of the data structure;
wherein the second component is configured to take over the data structure from the data connection, and
wherein the second component includes a conversion unit, which is configured to convert a taken-over data structure into a first object, that implements a predetermined abstract data type.

20. The system of claim 19, wherein the first component includes a sensor, the second component includes a control unit, and/or the transport component includes a data bus.
